(19) United States
(12) Patent Application Publication
(10) Pub. No.: US 2023/0025792 A1
(43) Pub. Date: Jan. 26, 2023

(54) ENVIRONMENTAL IMPACT EVALUATION APPARATUS, ENVIRONMENTAL IMPACT EVALUATION METHOD AND PROGRAM

(71) Applicant: NIPPON TELEGRAPH AND TELEPHONE CORPORATION, Tokyo (JP)

(72) Inventors: Machiko SHINOZUKA, Musashino-shi, Tokyo (JP); Takashi FURUTANI, Musashino-shi, Tokyo (JP); Yuriko TANAKA, Musashino-shi, Tokyo (JP)

(21) Appl. No.: 17/758,366

(22) PCT Filed: Jan. 29, 2020
(86) PCT No.: PCT/JP2020/003092

§ 371 Date: Jul. 5, 2022

(51) Int. Cl. G06F 11/30

(52) U.S. Cl. CPC G06F 11/30

(57) ABSTRACT

An environmental impact assessment device includes: an input unit configured to accept an input of a utilization purpose of an ICT service from a user, the ICT service being a target of assessment of a reduction effect for an environmental load; a first identification unit configured to refer to a storage unit in which, for each existing case about the assessment, an assessment result about the reduction effect for the environmental load for each activity item and a utilization purpose of the ICT service in the existing case are stored in association with each other, and to identify an existing case associated with the input utilization purpose; a second identification unit configured to identify an activity item for which the reduction effect is highest, for each existing case identified by the first identification unit; an acquisition unit configured to acquire a value of a parameter for an assessment expression for the environmental load, the assessment expression being previously set for each of the activity item identified by the second identification unit and utilization of an apparatus relevant to the ICT service; and a calculation unit configured to substitute the value acquired by the acquisition unit into the assessment expression, and to calculate a value of the environmental load for each of the activity item identified by the second identification unit and the utilization of the apparatus, and thereby, simplifies the assessment of the environmental load reduction effect due to the ICT service.

### TECHNICAL FIELD

The present invention relates to an environmental impact assessment device, an environmental impact assessment method, and a program.

### BACKGROUND ART

An ICT (Information and Communication Technology) service consumes electric power, but contributes to environmental load decrease because of reduction in resource consumption and movement. Many companies calculates a difference in CO₂ emissions between before and after the introduction of the ICT service, as a CO₂ reduction effect, by LCA (Life-Cycle Assessment), for emphasizing environmental load decrease effect due to the introduction of the ICT service.

For the calculation of the CO₂ reduction effect, there is a method for modeling by classifying the environmental impact due to the ICT service into a plurality of activity items, analyzing each activity item at stages of production, use and disposal, and considering what activity item matches with the ICT service that is planned to be introduced (For example, Non-Patent Literature 1).

### CITATION LIST

### Non-Patent Literature

Non-Patent Literature 1: Shinsuke Hannoe et al. “Kankyou asesumento kyoutsu-kiban no Kaihatsu (Development of Common Environmental Assessment Base)”, NTT Gijutsu Janaru (NTT Technology Journal), November 2012 issue, pp. 2S-32

### SUMMARY OF THE INVENTION

### Technical Problem

However, there is a problem in that it is not possible to easily determine what activity item matches with a certain ICT service, because it is necessary to have expertness relevant to functions and effects of the ICT service and environmental impact assessments.

The present invention has been made in view of the above point, and has an object to simplify the assessment of the environmental load reduction effect due to the ICT service.

### Means for Solving the Problem

For solving the above problem, an environmental impact assessment device includes: an input unit configured to accept an input of a utilization purpose of an ICT service from a user, the ICT service being a target of assessment of a reduction effect for an environmental load; a first identification unit configured to refer to a storage unit in which, for each existing case about the assessment, an assessment result about the reduction effect for the environmental load for each activity item and a utilization purpose of the ICT service in the existing case are stored in association with each other, and to identify an existing case associated with the input utilization purpose; a second identification unit configured to identify an activity item for which the reduction effect is highest, for each existing case identified by the first identification unit; an acquisition unit configured to acquire a value of a parameter for an assessment expression for the environmental load, the assessment expression being previously set for each of the activity item identified by the second identification unit and utilization of an apparatus relevant to the ICT service; and a calculation unit configured to substitute the value acquired by the acquisition unit into the assessment expression, and to calculate a value of the environmental load for each of the activity item identified by the second identification unit and the utilization of the apparatus.

### Effects of the Invention

It is possible to simplify the assessment of the environmental load reduction effect due to the ICT service.

### BRIEF DESCRIPTION OF DRAWINGS

FIG. 1 is a diagram showing an exemplary hardware configuration of an environmental impact assessment device 10 in an embodiment of the present invention.

FIG. 2 is a diagram showing an exemplary functional configuration of the environmental impact assessment device 10 in the embodiment of the present invention.

FIG. 3 is a flowchart for describing an example of a processing procedure that is executed by the environmental impact assessment device 10.

FIG. 4 is a diagram showing an exemplary display of a utilization purpose selection screen.

FIG. 5 is a diagram showing an exemplary configuration of an existing case DB 121.

FIG. 6 is a diagram showing an exemplary configuration of an activity item DB 122.

FIG. 7 is a diagram showing an exemplary display of a parameter input screen.

FIG. 8 is a diagram showing an exemplary input of the values of parameters.

FIG. 9 is a diagram showing an exemplary configuration of an assessment expression DB 124.

FIG. 10 is a diagram showing an exemplary output of calculation results of CO₂ emissions before and after introduction of a target service.

### DESCRIPTION OF EMBODIMENTS

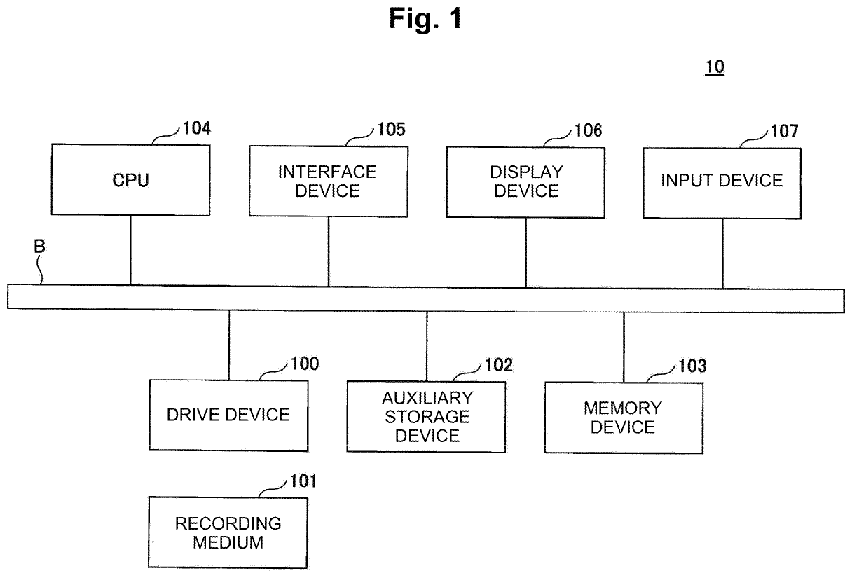

An embodiment of the present invention will be described below based on the drawings. FIG. 1 is a diagram showing an exemplary hardware configuration of an environmental impact assessment device 10 in the embodiment of the present invention. The environmental impact assessment device 10 in FIG. 1 includes a drive device 100, an auxiliary storage device 102, a memory device 103, a CPU 104, an interface device 105, a display device 106 and an input device 107 that are connected with each other by a bus B.

A program that realizes processing in the environmental impact assessment device 10 is provided by a recording medium 101 such as a CD-ROM. When the recording medium 101 holding the program is set in the drive device 100, the program is installed in the auxiliary storage device 102 from the recording medium 101 through the drive device 100. The program does not always need to be installed from the recording medium 101, and may be downloaded from another computer through a network. The auxiliary storage device 102 holds the installed program, and holds necessary files, data and the like.

The memory device 103 reads the program from the auxiliary storage device 102 and holds the program, in response to an activation instruction for the program. The CPU 104 realizes functions about the environmental impact assessment device 10, in accordance with the program held in the memory device 103. The interface device 105 is used as an interface for connection with a network. The display device 106 displays a GUI (Graphical User Interface) by the program, and the like. The input device 107 is constituted by a keyboard, a mouse and the like, and is used for input of various operation instructions.

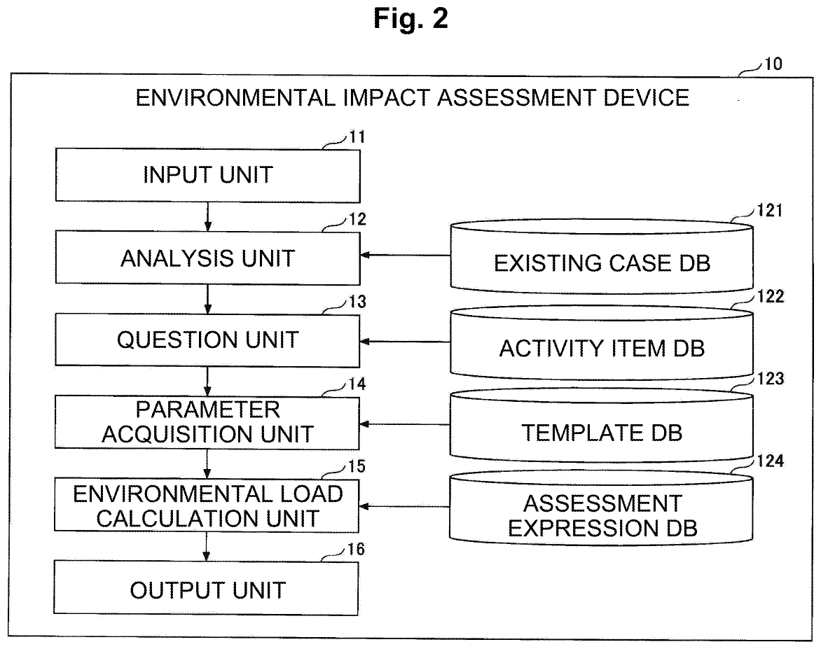

FIG. 2 is a diagram showing an exemplary functional configuration of the environmental impact assessment device 10 in the embodiment of the present invention. In FIG. 2, the environmental impact assessment device 10 includes an input unit 11, an analysis unit 12, a question unit 13, a parameter acquisition unit 14, an environmental load calculation unit 15, an output unit 16 and the like, for allowing the assessment of the environmental impact (the reduction effect for an environmental load (the effect of the reduction in CO₂ emissions)) due to the introduction of an ICT (Information and Communication Technology) service that is a target of the assessment based on LCA (Life-Cycle Assessment) without having expertness relevant to functions and effects of the ICT service and environmental impact assessments. The units are realized by processing in which the CPU 104 executes one or more programs installed in the environmental impact assessment device 10. The environmental impact assessment device 10 utilizes databases (storage unit) such as an existing case DB 121, an activity item DB 122, a template DB 123 and an assessment expression DB 124. For example, the databases can be realized using the auxiliary storage device 102, a storage device that can be connected with the environmental impact assessment device 10 through a network, or the like.

It is necessary to determine a functional unit of the ICT service for calculating the reduction effect (CO₂ reduction effect) for the environmental load due to the introduction of the ICT service that is an assessment target based on LCA. The functional unit of the ICT service means what the function to be served by the ICT service is (that is, for what purpose the ICT service is utilized). In the embodiment, the functional unit is almost synonymous with a utilization purpose of the ICT service.

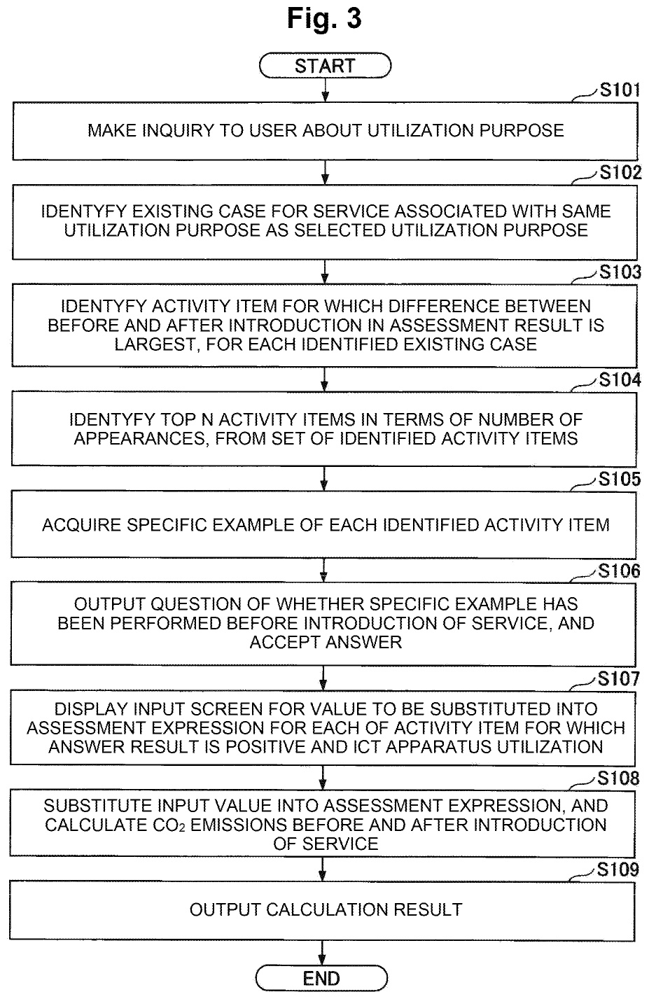

A processing procedure that is executed by the environmental impact assessment device 10 will be described below. FIG. 3 is a flowchart for describing an example of the processing procedure that is executed by the environmental impact assessment device 10.

In step S101, the input unit 11 makes an inquiry to a user (assessment person) about the utilization purpose of the ICT service (referred to as a “target service”, hereinafter) that is an assessment target. For example, the target service is an ICT service that is planned to be introduced or has been introduced by the user. In the embodiment, as an example, the target service is a TV conference system.

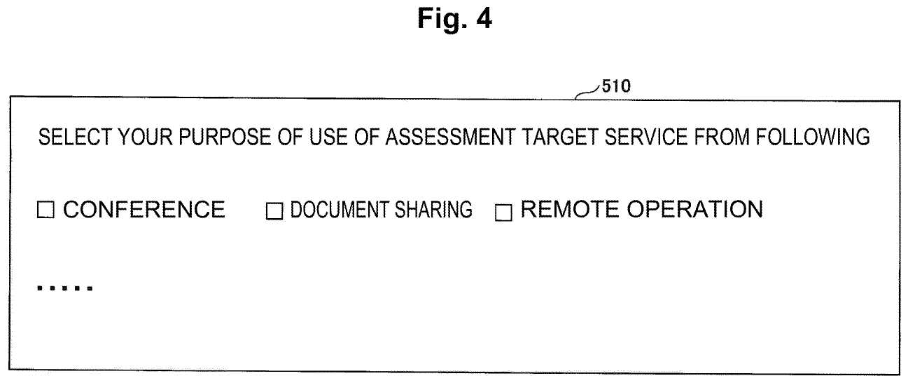

For example, the inquiry about the utilization purpose of the target service may be made by displaying a screen shown in FIG. 4 on the display device 106.

FIG. 4 is a diagram showing an exemplary display of a utilization purpose selection screen. In FIG. 4, a utilization purpose selection screen 510 includes radio buttons whose options are utilization purposes. Accordingly, on the utilization purpose selection screen 510, one utilization purpose can be selected. The options as the utilization purposes are previously determined as described later.

When the user selects one utilization purpose, the input unit 11 accepts the utilization purpose (referred to as a “target utilization purpose”, hereinafter), as the utilization purpose of the target service. For example, when the target service is a TV conference system, “conference” is selected as the utilization purpose.

Subsequently, the analysis unit 12 refers to the existing case DB 121, and identifies an existing LCA case that is associated with the same utilization purpose as the target utilization purpose (S102).

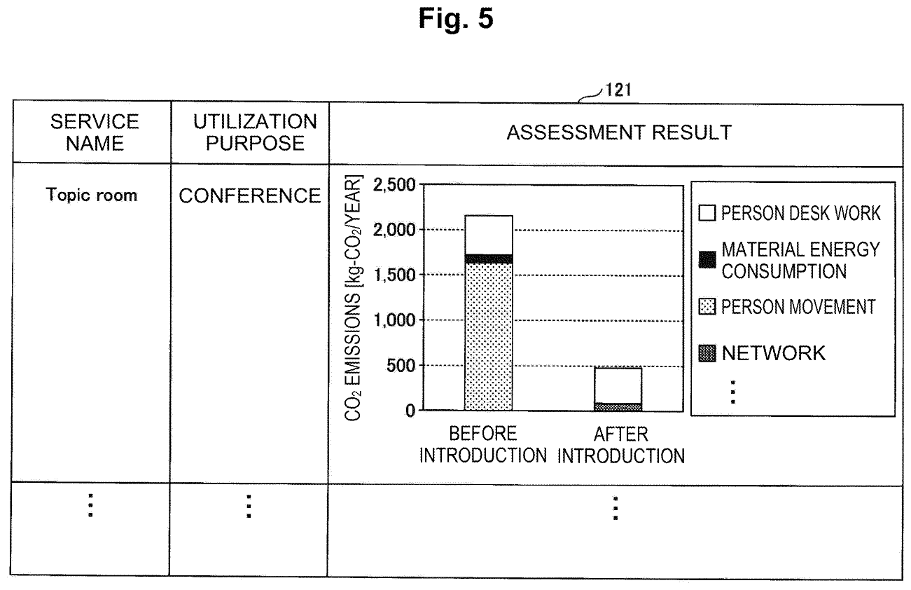

FIG. 5 is a diagram showing an exemplary configuration of the existing case DB 121. As shown in FIG. 5, in the existing case DB 121, a record in which the utilization purpose is given (labeling) to a service name and assessment result for each assessment case (referred to as an “existing case”, hereinafter) about a reduction effect for an existing environmental load based on LCA (that is, for each ICT service for which the reduction effect for the environmental load based on LCA) has been assessed is stored. For example, the existing case only need to be an existing LCA case that has been published, and does not need to be a LCA case that has been executed by the user.

The service name is the name of the ICT service for the existing case. The assessment result is information indicating an assessment result for the existing case, that is, the reduction effect for the environmental load due to the introduction of the ICT service, for each activity item. In FIG. 5, a bar graph indicating the environmental load (CO₂ emissions) for each activity item before the introduction of the ICT service and a bar graph indicating the environmental load (CO₂ emissions) for each activity item after the introduction of the ICT service are shown as an example of the assessment result. The activity item is synonymous with the activity item disclosed in Non-Patent Literature 1. In Non-Patent Literature 1, characteristics of the activity relevant to the ICT service are classified into eight, activity items: ICT apparatus utilization, software utilization, network infrastructure utilization, person movement, object movement, material energy consumption, object preservation and person desk work.

The utilization purpose is the utilization purpose of the ICT service for the existing case. For example, an expert previously defines a plurality of utilization purposes, and gives (labeling) one of the plurality of utilization purposes to each existing case. The labeling of the utilization purpose is performed from a standpoint of what is performed using the ICT service or what is replaced using the ICT service. The utilization purpose is a purpose of using the function of the ICT service. For example, when the function of a certain ICT service is “accumulation”, the purpose of utilizing the function “accumulation” is regarded as “sharing of documents and the like”. Thereby, it is possible to appropriately derive the functional unit.

The utilization purposes displayed as options on the utilization purpose selection screen 510 in FIG. 4 are a plurality of utilization purposes previously defined as candidates of the labeling by the expert.

In step S102, the existing case (IC service) associated with the same utilization purpose as the target utilization purpose is identified. Hereinafter, the existing case identified in step S102 is referred to as a “target existing case”. Note that a plurality of target existing cases can be identified.

Subsequently, for each target existing case, the analysis unit 12 calculates the difference (reduction effect) in CO₂ emissions between before and after the introduction of the ICT service in the assessment result, by category of the activity item, and identifies an activity item having the largest difference (S103). For example, when there are ten target existing cases, one activity item is identified for each of the ten target existing cases.

Subsequently, the question unit 13 identifies activity items for which the number of appearances is relatively large (top N activity items), from a set of the identified activity items (S104). For example, N is 2. On this occasion, for example, in the case where five activity items of the ten activity items fall under an activity item A, where three activity items fall under an activity item B, and where the remaining two activity items are other than the activity items A and B, the largest activity item in terms of the number of appearances is A, and the second largest activity item is B. In the case where all the ten activity items fail under A, only A is identified in step S104. Further, N may be 3 or more. Hereinafter, the activity item identified in step S104 is referred to as a “before-introduction activity item candidate”.

Subsequently, the question unit 13 acquires a specific example of each before-introduction activity item candidate, from the activity item DB 122 (S105).

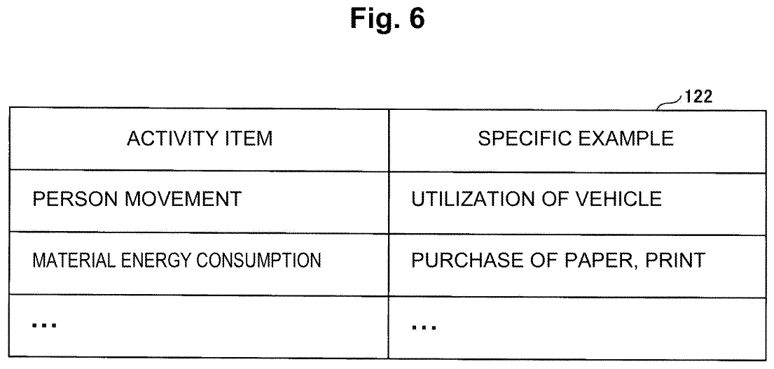

FIG. 6 is a diagram showing an exemplary configuration of the activity item DB 122. As shown in FIG. 6, for each activity item, a specific example of the activity item is previously registered in the activity item DB 122. The specific example is information indicating a specific case of the activity item. The specific example of each activity item may be previously registered by the expert, for example.

Subsequently, for each before-introduction activity item candidate, the question unit 13 outputs a question of whether the user has performed the specific example acquired for the before-introduction activity item candidate before the introduction of the target service, and accepts an input of an answer to the question, from the user (S106). For example, when the before-introduction activity item candidate is “person movement”, the specific example of “person movement” is “utilization of vehicle” in the example of FIG. 6. Accordingly, in this case, a question “Has the utilization of vehicles been performed before the introduction of the ICT service that is the assessment target?” is output. For example, the output of the question and the acceptance of the answer may be performed by displaying a screen including the question and including buttons corresponding to a positive option (for example, “Yes” or the like) and a negative option (for example, “No” or the like), on the display device 106.

Subsequently, on the display device 106, the parameter acquisition unit 14 displays a parameter input screen for accepting an input of the value of a parameter to be substituted into an assessment expression (a calculation expression for CO₂ emissions) for the environmental load, from the user, for each of the before-introduction activity item candidate (referred to as a “before-introduction activity item”, hereinafter) for which the answer is positive and “ICT apparatus utilization” (S107). The reason why not only the before-introduction activity item but also the activity item “ICT apparatus utilization” are adopted as the assessment target for the environment load is that the activity item after the introduction of the target service is fixed to “ICT apparatus utilization” for convenience sake in the embodiment. That is, the before-introduction activity item is an activity item that has been performed before the introduction of the target service, and is an activity item for which the reduction effect for the environmental load is relatively large in the existing case. Meanwhile, in the case where some kind of ICT service is introduced, the activity item that is mainly performed is “ICT apparatus utilization”. Accordingly, in the embodiment, the reduction effect for the environmental load before and after the introduction of the target service is assessed by comparison of the respective environmental loads (CO₂ emissions) of the before-introduction activity item and “ICT apparatus utilization” after the introduction of the target service.

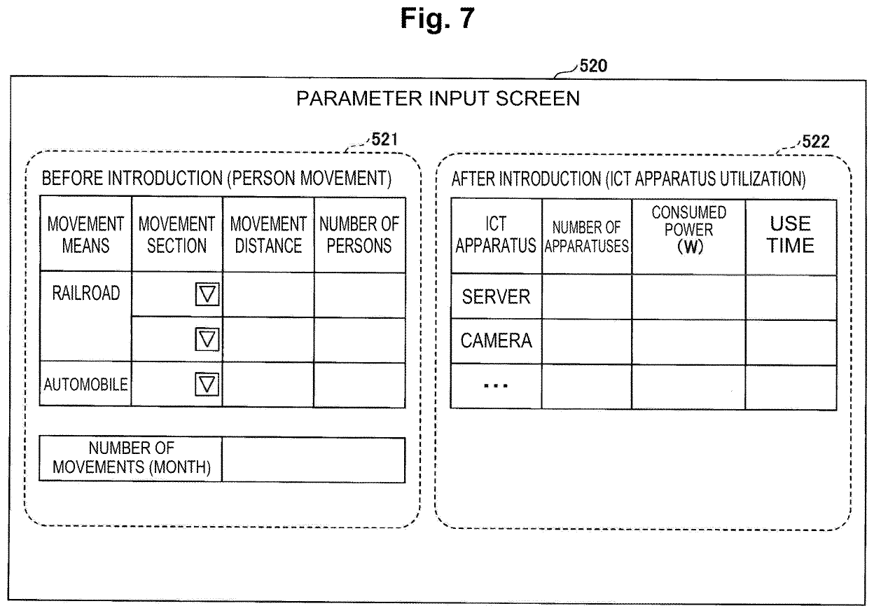

Accordingly, in the case where the before-introduction activity item is “person movement” for example, a parameter input screen shown in FIG. 7 is displayed in step S107, for example.

FIG. 7 is a diagram showing an exemplary display of the parameter input screen. In FIG. 7, the parameter input screen 520 includes an input region 521 and an input region 522. The input region 521 is an input region for values of parameters for the before-introduction activity item (“person movement”). The input region 522 is an input region for parameters for “ICT apparatus utilization”.

The input region 521 includes input fields of a movement section, a movement distance and the number of persons, for each movement means (a railroad and an automobile). The movement section is a combination of a start point and end point of a movement, and for example, a value such as “Tokyo-Osaka” is input. The movement distance is the distance of the movement section. The number of persons is the number of persons that move. In the example of FIG. 7, the input field of the movement section is a combo box, and the selection can be performed from previously set options. For example, the user inputs the movement section, the movement distance and the number of persons about a movement of persons that is necessary for one execution of a predetermined conference (a conference that is executed in the TV conference system after the introduction of the target service (TV conference system)) before the introduction of the target service (that is, about a movement that becomes unnecessary by the introduction of the target service). In the case where the movement distance can be automatically calculated from the movement section, the parameter acquisition unit 14 may automatically input the value of the movement distance in response to the input of the movement section, without being manually input by the user. Further, for a field of the number of conferences, the user inputs the number of movements for the predetermined conference in one month (that is, the number of times of the predetermined conference in one month), to a field “number of movements (month)”. For example, the number of movements may be a monthly average value of past actual results, or may be an actual result value in the last one month before the introduction of the target service.

On the other hand, the input region 522 includes fields of the number of apparatuses, a consumed power and a use time, for each ICT apparatus that is expected to be used in the ICT system. To a line including the name of each ICT apparatus that actually constitutes the target service, the user inputs the number of apparatuses, the consumed power and the use time for the ICT apparatus. For example, the use time is the time of use of each ICT apparatus during the utilization of the target service in the latest one month. The name of the ICT apparatus may be input by the user. The consumed power may be input by reference to a specification document and the like of each ICT apparatus.

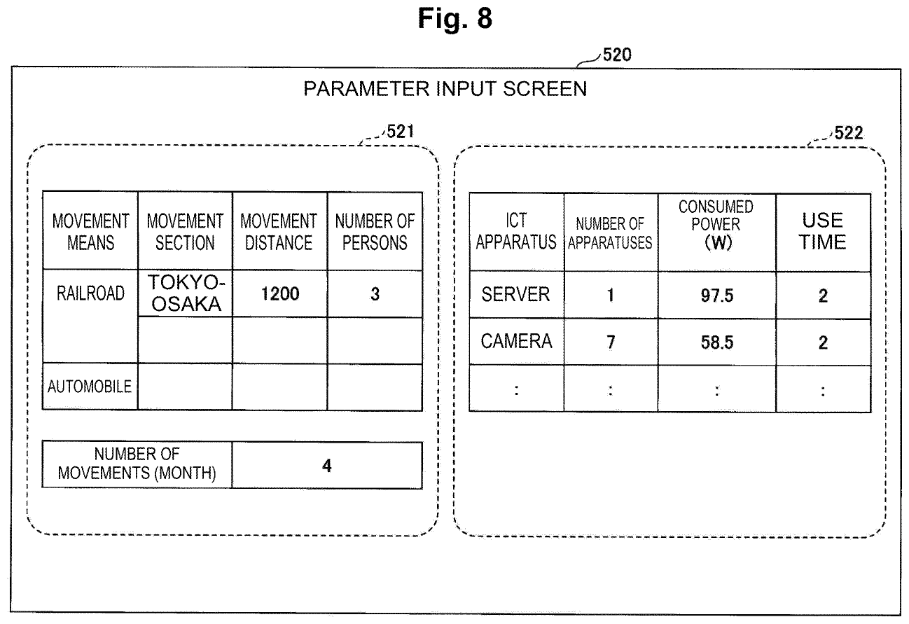

FIG. 8 shows an exemplary input of the values of the parameters. The parameter acquisition unit 14 may acquire configuration information in a system for the target service from a previously set address (a URL or the like) through a network, and may acquire ICT apparatuses constituting the target service, and the number of apparatuses and the consumed power for each ICT apparatus, from the configuration information. Further, the use time for each ICT apparatus may be calculated by the parameter acquisition unit 14, for example, from log data (use history) of the target service or log data (use history) of each ICT apparatus. In this case, the user does not need to perform the input to the input region 522. Accordingly, in this case, the input region 522 does not need to be displayed on the parameter input screen 520.

The parameter acquisition unit 14 generates the parameter input screen 520 by reference to the template DB 123. In the template DB 123, a template of an input region for parameters is stored for each activity item. The parameter acquisition unit 14 generates the parameter input screen 520, such that the parameter input screen 520 includes a template of an input region corresponding to the before-introduction activity item and a template of an input region corresponding to “ICT apparatus utilization”.

After the input of the values of the parameters finishes, the environmental load calculation unit 15 substitutes input results of the values of the parameters into assessment expressions previously stored in the assessment expression DB 124, and calculates the CO₂ emissions before the introduction of the target service and the CO₂ emissions after the introduction of the target service (S108).

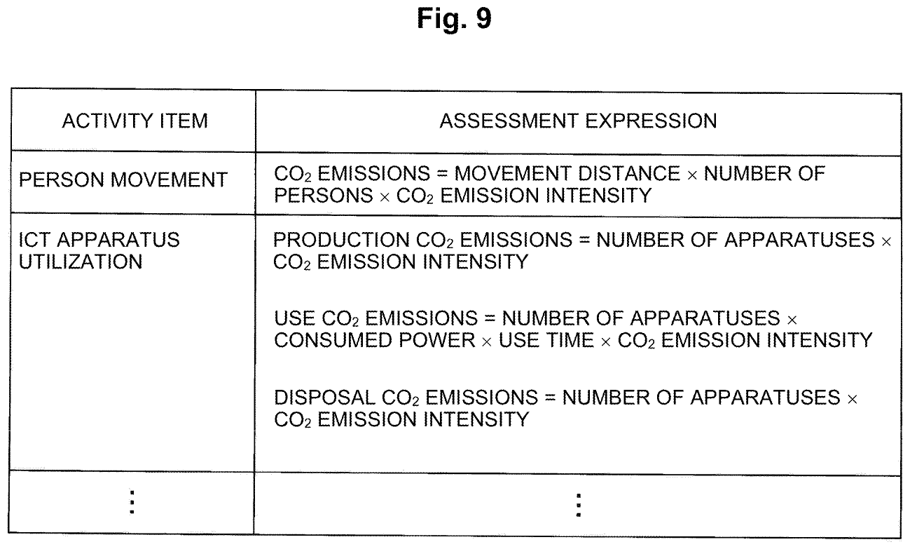

FIG. 9 is a diagram showing an exemplary configuration of the assessment expression DB 124. As shown in FIG. 9, for each activity item, an assessment expression (a calculation expression for CO₂ emissions) for the environmental load due to the activity item is stored in the assessment expression DB 124. For “ICT apparatus utilization”, CO₂ is emitted at life cycle stages of the production, use and disposal of the ICT apparatus, and therefore, an assessment expression is stored for each of the life cycle stages.

“CO₂ emission intensity” in each assessment expression is a factor (conversion factor) for converting the amount of the activity item into the CO₂ emissions, and differs for each activity item and for each means that is utilized in the activity item. For example, as for “person movement”, the CO₂ emission intensity differs for each movement means (the railroad, the automobile and the like). Further, as for “ICT apparatus utilization”, the CO₂ emission intensity differs for each ICT apparatus and for each of the life cycle stages of production, use and disposal (for each of production CO₂ emissions, use CO₂ emissions and disposal CO₂ emissions). Accordingly, the value of the CO₂ emission intensity may be stored in another DB. Alternatively, in the assessment expression DB 124, as to the assessment expression for “person movement”, an assessment expression may be stored for each combination of “person movement” and “movement means”, and as to the assessment expression for “ICT apparatus utilization”, an assessment expression may be stored for each ICT apparatus.

In the embodiment, the CO₂ emissions before the introduction of the target service is estimated from the CO₂ emissions due to the before-introduction activity item. Further, the CO₂ emissions after the introduction of the target service is estimated from the CO₂ emissions due to “ICT apparatus utilization”. Accordingly, the environmental load calculation unit 15 calculates the CO₂ emissions before the introduction of the target service, based on the assessment expression stored in the assessment expression DB 124 for the before-introduction activity item, and calculates the CO₂ emissions after the introduction of the target service, based on the assessment expression stored in the assessment expression DB 124 for “ICT apparatus utilization”.

For example, suppose that the input result to the input, region 521 on the parameter input screen 520 are an input result shown in FIG. 8 and the CO₂ emission intensity for the person movement by railroad is 0.0000236 t-CO₂/km-person. Further, in the embodiment, suppose that the CO₂ emissions for five years, which are durable years of the TV conference system, are calculated. In this case, the CO₂ emissions before the introduction of the target, service are calculated as follows.

CO₂ emissions=the movement distance×the number of persons×the CO₂ emission intensity for railroad movement×the number of conferences×12×the number of years=1200 km×3 persons×0.0000236 t-CO₂/km-person×4 conferences×12×5 years=20.4 t-CO₂

Similarly, the CO₂ emissions after the introduction of the target service is calculated as 11.4 t-CO₂, for example. The CO₂ emissions after the introduction of the target service is derived by calculating the total of production CO₂ emissions, use CO₂ emissions and disposal CO₂ emissions in the assessment expression for “ICT apparatus utilization” in FIG. 9 for each of a server, a camera and the like and summing the calculation results for the respective ICT apparatuses.

In the calculation of the CO₂ emissions for each ICT apparatus, a value for each model number of the ICT apparatus may be used as the CO₂ emission intensity, but in the case of being difficult, the respective CO₂ emission intensities for production, use and disposal may be registered for each class (a server, a camera and the like) based on the function and purpose of the ICT apparatus, and the CO₂ emission intensities may be used for calculation.

Alternatively, the CO₂ emissions per unit price (for example, per one million yen) may be set for each of production, use and disposal, as the CO₂ emission intensity for each class based on the function and purpose of the ICT apparatus, and the CO₂ emission intensities for the production, use and disposal of each ICT apparatus may be calculated based on the price of an ICT apparatus that is actually used.

For example, suppose that 2.78 t-CO₂/one million yen is registered as the CO₂ emissions for the production of one server per one million yen. In this case, when a server with 1.38 million yen/one server is used, the production CO₂ emissions for the server may be calculated as follows.

2.78 t-CO₂/one million yen×1.38 million yen×one server=3.83 t-CO₂

That is, in this case, the CO₂ emission intensity for the production of the server is calculated by 2.78 t-CO₂/one million yen×1.38 million yen.

The CO₂ emissions for the use and disposal of the server also may be calculated using CO₂ emission intensities based on similar calculation methods, and the CO₂ emissions for the server may be calculated by summing the respective calculation results. For other ICT apparatuses also, similar calculations may be performed.

Subsequently, the output unit 16 outputs the calculation results by the environmental load calculation unit 15 (S109).

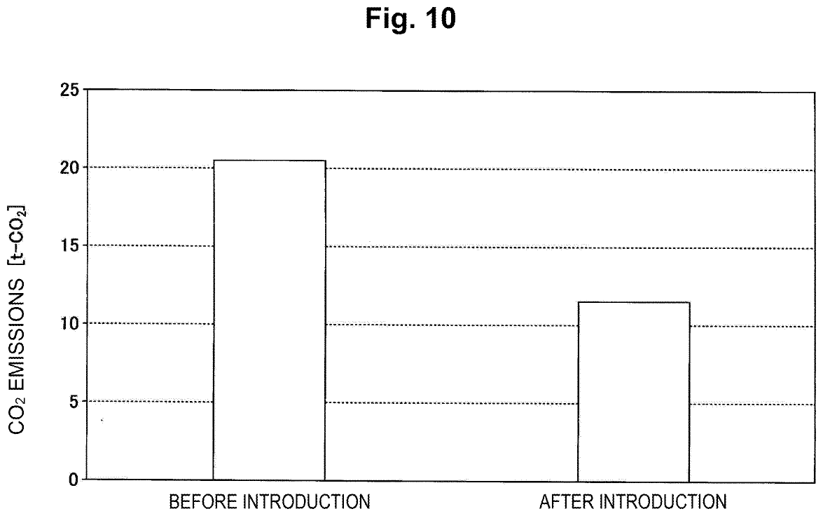

FIG. 10 is a diagram showing an exemplary output of the calculation results of the CO₂ emissions before and after the introduction of the target service. In FIG. 10, both of the CO₂ emissions before the introduction of the target service and the CO₂ emissions after the introduction of the target service are shown by bar graphs. For example, the output unit 16 may display the bar graphs on the display device 106.

Further, for showing the reduction effect for the environmental load in a more understandable manner, the output unit 16 may display 9 t-CO₂, which is the difference (the CO₂ emissions before and after the introduction—the CO₂ emissions after the introduction) between the CO₂ emissions before the introduction and the CO₂ emissions after the introduction, on the display device 106. The reduction effect may be expressed as 56% (≈11.4÷20.4×100).

An example in which the ICT apparatus has not been utilized before the introduction of the target service has been shown above. However, in the case where an ICT apparatus substituted in a TV conference system has been utilized in a conference before the introduction of the target service and where the activity item as the utilization of the ICT apparatus is identified as the before-introduction activity item, the CO₂ emissions relevant to the ICT apparatus are calculated in the calculation of the CO₂ emissions before the introduction of the target service.

As described above, according to the embodiment, without the assessment person assuming situations before and after the introduction of the ICT service from scratch to build a model by oneself, by inputting the answer to the question or the value of the parameter, the situations before and after the introduction of the ICT service are automatically identified and the reduction effect for the environmental load before and after the introduction of the ICT service is calculated. As a result, it is possible to simplify the assessment of the environmental load reduction effect due to the ICT service. Accordingly, it is possible to assess the CO₂ reduction effect due to the ICT service, without having expertness relevant to the environmental impact assessment and the ICT service. Thereby, it is possible to easily calculate the CO₂ reduction effect depending on the utilization situation of an individual user, and to promote the ICT service from an environmental aspect in business activity.

In the embodiment, the analysis unit 12 is an example of the first identification unit and the second identification unit. The parameter acquisition unit 14 is an example of the acquisition unit. The environmental load calculation unit 15 is an example of the calculation unit.

The embodiment, of the present invention has been described above in detail. The present invention is not limited to the particular embodiment, and various modifications and alterations can be made in the scope of the spirit of the present invention described in the claims.

### Reference Signs List

10 Environmental impact assessment device

11 Input unit

12 Analysis unit

13 Question unit

14 Parameter acquisition

15 Environmental load calculation unit

16 Output unit

100 Drive device

101 Recording medium

102 Auxiliary storage device

103 Memory device

104 CPU

105 interface device

106 Display device

107 Input device

121 Existing case DB

122 Activity item DB

123 Template DB

124 Assessment expression DB

B Bus

1. An environmental impact assessment device comprising:
a processor; and
a memory storing program instructions that cause the processor to:
accept an input of a utilization purpose of an ICT service horn a user, the ICT service being a target of assessment of a reduction effect for an environmental load;
refer to a storage unit in which, for each existing case about the assessment, an assessment result about the reduction effect for the environmental load for each activity item and a utilization purpose of the ICT service in the existing case are stored in association with each other, and identify an existing case associated with the input utilization purpose;
identify an activity item for which the reduction effect is highest, for each existing case that is the identified existing case;
acquire a value of a parameter for an assessment expression for the environmental load, the assessment expression being previously set for each of the identified activity item and utilization of an apparatus relevant to the ICT service; and
substitute the acquired value into the assessment expression, and calculate a value of the environmental load for each of the identified activity item and the utilization of the apparatus.

2. The environmental impact assessment device according to claim 1, wherein
the processor is further configured to output a question of whether the activity item has been performed before introduction of the ICT service that is the target of the assessment, for each activity item that is the identified activity item and for which the number of appearances is relatively large, and to accept an answer to the question, and
the processor accepts, from the user, an input of the value to be substituted into the assessment expression, for an activity item that is the identified activity item and for which the answer to the output question is positive.

3. The environmental impact assessment device according to claim 1, wherein the processor acquires the value to be substituted into the assessment expression for the utilization of the apparatus, from configuration information about the apparatus and a use history of the apparatus for the ICT service.

4. An environmental impact assessment method for execution by a computer, the environmental impact assessment method comprising:
accepting an input of a utilization purpose of an ICT service from a user, the ICT service being a target of assessment of a reduction effect for an environmental load;
referring to a storage suit in which, for each existing case about the assessment, an assessment result about the reduction effect for the environmental load for each activity item and a utilization purpose of the ICT service in the existing case are stored in association with each other, and identifying an existing case associated with the input utilization purpose;
identifying an activity item for which the reduction effect is highest, for each existing case that is the identified existing case;
acquiring a value of a parameter for an assessment expression for the environmental load, the assessment expression being previously set for each of the identified activity item and utilization of an apparatus relevant to the ICT service; and
substituting the acquired value into the assessment expression, and calculating a value of the environmental load for each of the identified activity item and the utilization of the apparatus.

5. The environmental impact assessment method according to claim 4, the environmental impact assessment method further comprising
outputting a question of whether the activity item has been performed before introduction of the ICT service that is the target of the assessment, for each activity item that is the identified activity item and for which the number of appearances is relatively large, and accepting an answer to the question,
wherein the acquiring of the value includes accepting, from the user, an input of the value to be substituted into the assessment expression, for an activity item that is the identified activity item and for which the answer to the output question is positive.

6. The environmental impact assessment method according to claim 4, wherein the acquiring of the value includes acquiring the value to be substituted into the assessment expression for the utilization of the apparatus, from configuration information about the apparatus and a use history of the apparatus for the ICT service.

7. A non-transitory computer-readable recording medium having stored therein a program that causes a computer to execute the environmental impact assessment method according to claim 4.
